(19) United States
(12) Patent Application Publication
(10) Pub. No.: US 2018/0042416 A1
(43) Pub. Date: Feb. 15, 2018

(54) Sanitary Utensil

(71) Applicant: David Kopke, Sterling Heights, MI (US)

(72) Inventor: David Kopke, Sterling Heights, MI (US)

(21) Appl. No.: 15/674,110

(22) Filed: Aug. 10, 2017

Related U.S. Application Data
(60) Provisional application No. 62/373,404, filed on Aug. 11, 2016.

(51) Int. Cl. A47G 21/00; A47G 21/04; B25G 1/10; A47G 21/02

(52) U.S. Cl. CPC A47G 21/00; A47G 21/02; A47G 21/04; B25G 1/10; A47G 2400/02

(57) ABSTRACT

A sanitary utensil. The sanitary utensil includes a body having a first end and a second end each disposed along a first horizontal plane. A first contact point disposed on the first end of the body and a second contact point disposed on the second end of the body are configured to contact a surface when the body is placed thereon. A middle portion disposed between the first end and the second end of the body includes an arcuate member having an apex disposed on a second horizontal plane. A tool disposed on the second end of the body extends upwardly in a direction opposing the first end. The tool is configured to be elevated above a surface when the body is placed thereon.

### CROSS REFERENCE TO RELATED APPLICATIONS

This application claims the benefit of U.S. Provisional Application No. 62/373,404 filed on Aug. 11, 2016. The above identified patent application is herein incorporated by reference in its entirety to provide continuity of disclosure.

### BACKGROUND OF THE INVENTION

The present invention relates to food utensils. More specifically, the present invention provides a sanitary utensil configured to elevate the tool end of the utensil above a support surface, such as a table or counter, when the utensil is placed thereon.

Many individuals utilize utensils such as forks, spoons, and knives in order to manipulate food. These utensils are typically placed on a support surface, such as a table or counter when not in use. Typical utensils include a body portion, a handle portion, and a tool portion that manipulates food, such as a spoon, fork, knife, spatula, or the like. When a typical utensil is placed on a surface, the tool end contacts the surface and supports the utensil thereon. If the support surface has contaminates such as bacteria, food material, or the like, the contaminates may be transferred to the tool portion of the utensil. This unwanted contamination of the tool portion of the utensil can cause the user to become sick. In order to address these concerns, the present invention provides a sanitary utensil that elevates the tool end of the utensil above a support surface, so that the tool end does not contact the support surface, thereby preventing contamination of the sanitary utensil.

In light of the food utensils disclosed in the known art, it is submitted that the present invention substantially diverges in design elements from the known art and consequently it is clear that there is a need in the art for an improvement to existing food utensils. In this regard, the present invention substantially fulfills these needs.

### SUMMARY OF THE INVENTION

In view of the foregoing disadvantages inherent in the known types of food utensils now present in the prior art, the present invention provides a sanitary utensil wherein the same can be utilized for providing convenience for the user when maintaining the tool end of the utensil in a sanitary state.

In one example of the present invention, the sanitary utensil includes a body having a first end and a second end, wherein each of the first end and the second end are disposed along a common first horizontal plane. A first contact point disposed on the first end of the body and a second contact point disposed on the second end of the body are each configured to contact a surface when the body is placed thereon. A middle portion disposed between the first end and the second end of the body includes an arcuate member having an apex disposed in a second horizontal plane, wherein the second horizontal plane is elevated above the first horizontal plane. A tool disposed on the second end of the body extends upwardly in a direction opposing the first end of the body. The tool is configured to be elevated above a surface when the body is supported thereon.

In one embodiment of the present invention, a front portion and a rear portion disposed on opposing sides of the first contact point of the body extend upwardly from the first contact point. The front portion tapers inwardly from the first contact point towards the tool and the rear portion tapers inwardly from the first contact point towards the second end of the body. This in conjunction with the arcuate member allows multiple sanitary utensils to be easily stacked on one another for storage purposes.

An object of the present invention is to provide a sanitary utensil that elevates the tool end above its supporting surface such that the tool end does not contact the supporting surface, which prevents any germs or other particles from contaminating the tool portion of the sanitary utensil.

Other objects, features, and advantages of the present invention will become apparent from the following detailed description taken in conjunction with the accompanying.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top plan view of a first embodiment of the sanitary utensil.

FIG. 2 shows a perspective view of a first embodiment of the sanitary utensil.

FIG. 3 shows a perspective view of a second embodiment of the sanitary utensil.

FIG. 4 shows a side view of a second embodiment of the sanitary utensil.

FIG. 5 shows a perspective view of a third embodiment of the sanitary utensil.

### DETAILED DESCRIPTION OF THE INVENTION

Reference is made herein to the attached drawings. Like reference numerals are used throughout the drawings to depict like or similar elements of the sanitary utensil. For the purposes of presenting a brief and clear description of the present invention, the preferred embodiment will be discussed as used for manipulating food articles. The figures are intended for representative purposes only and should not be considered to be limiting in any respect.

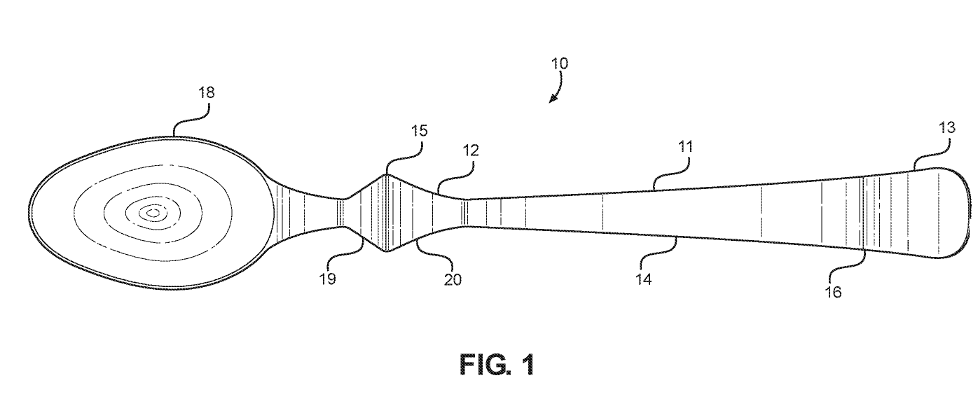

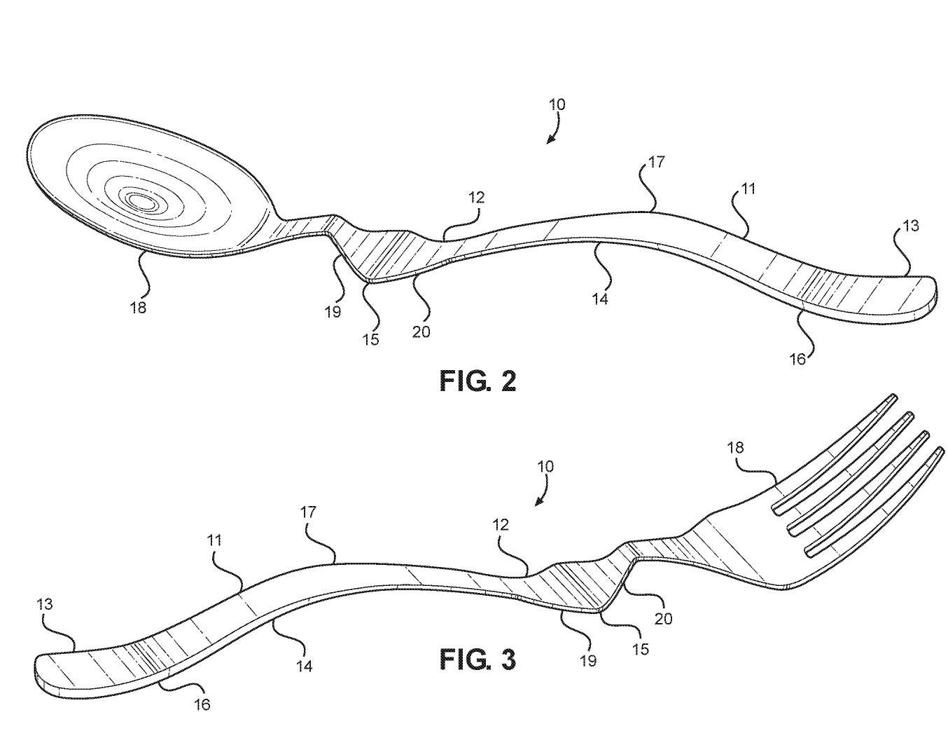

Referring now to FIGS. 1 and 2, there is shown a top plan view of a first embodiment of the sanitary utensil and a perspective view of a first embodiment of the sanitary utensil, respectively. The sanitary utensil 10 includes a body 11 having a first end 12, a second end 13, and a middle portion 14 therebetween, the middle portion 14 defining an arcuate portion having an apex 17 disposed in a first horizontal plane. A tool portion 18 extends outwardly from the first end 12 of the body 11. In the shown embodiment, the body 11 tapers inwardly from the second end 13 toward the first end 12 thereof. Further, in the shown embodiment, the tool portion 18 comprises a spoon. However, in alternate embodiments, the tool end 18 may comprise a fork, a knife, or any other typical food manipulating tool.

The first end 12 of the body 11 comprises a first contact point 15 and the second end 13 of the body 11 comprises a second contact point 16. The first contact point 15 and the second contact point 16 are configured to contact a surface, such as a table or countertop, when the sanitary utensil 10 is placed thereon, so that the tool portion 18 is elevated above the surface, preventing contamination thereof. In the shown embodiment, the second end 13 of the body 11 curves upwardly from the second contact point 16 in a direction opposing the first end 12 of the body 11, so that the portion of the sanitary utensil 10 that is grasped by a user does not contact the surface upon which the sanitary utensil 10 is supported.

The first end 12 of the body 11 is shaped to facilitate stacking of multiple sanitary utensils 10 for storage purposes. The first end 12 of the body 11 includes a front portion 19 adjacent the tool portion 18 and a rear portion 20 adjacent the second end 13 of the body 11. The front portion 19 tapers inwardly from the first contact point 15 towards the tool portion 18, and the rear portion 20 tapers inwardly from the first contact point 15 toward the second end 13 of the body 11, such that the first end 12 of the body 11 is widest at the contact point 15. In this way, the first end 12 of the body 11 provides a stable and widened surface upon which another sanitary utensil 10 may be stacked.

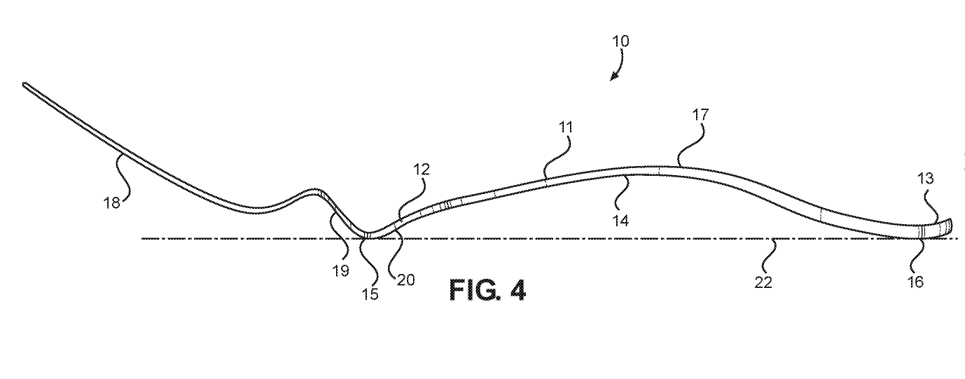

Referring now to FIGS. 3 and 4, there is shown a perspective view of a second embodiment of the sanitary utensil and a side view of a second embodiment of the sanitary utensil, respectively. In the shown embodiment, the tool portion 18 comprises a fork. The front portion 19 of the first end 12 of the body 11 extends upwardly from the first contact point 15 toward the tool portion 18, while the rear portion 20 of the first end 12 of the body 11 extends upwardly from the first contact point 15 towards the second end 13 of the body 11. In the shown embodiment, the front portion 19 extends upwardly from the first contact point 15 at an angle greater than that of the rear portion 20, so that the tool portion 18 is further elevated above a surface 22 upon which the sanitary utensil 10 is supported. The apex 17 of the middle portion 14 is disposed in a first horizontal plane, and the first and second contact points 15, 16 are both disposed in a second horizontal plane, wherein the first horizontal plane is elevated above the second horizontal plane, as shown in FIG. 4.

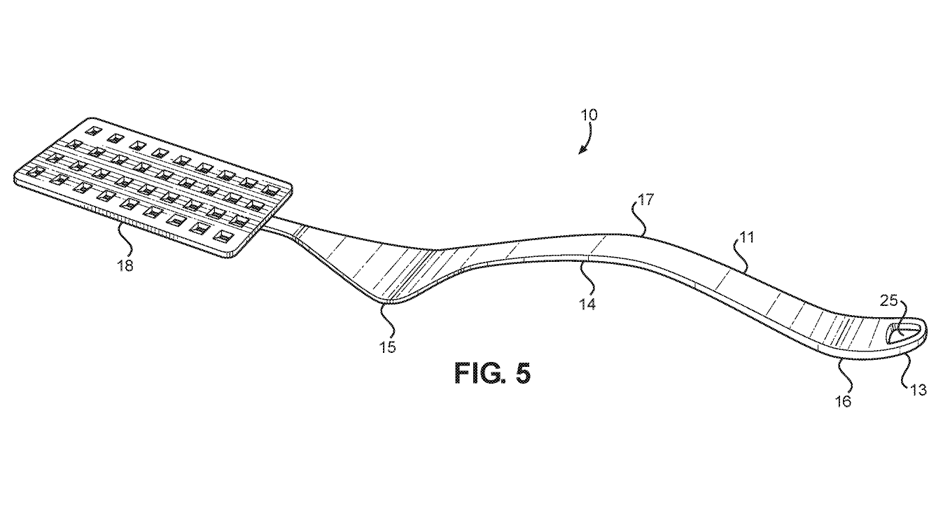

Referring now to FIG. 5, there is shown a perspective view of a third embodiment of the sanitary utensil. In addition to eating tools such as forks, spoons, and knives, the sanitary utensil 10 may also include a larger tool portion 18 generally used for preparing or serving food, such as a spatula. In the shown embodiment, the first contact point 15 comprises a curved outer edge which further facilitates stacking of multiple sanitary utensils 10. Further, in the shown embodiment, the tool portion 18 is elevated above the first contact point 15 and the second contact point 16, and the apex 17 of the middle portion 14 of the body 11 is elevated above the tool portion 18. In some embodiments, the second end 13 of the body includes an aperture 25 thereon. The aperture 25 may be utilized to hang the sanitary utensil 10 from a support surface such as a hook when the sanitary utensil 10 is not in use.

The sanitary utensil 10 may be composed of any suitably durable material, such as, for example, plastic, metal, or wood. Further, in one embodiment, the sanitary utensil 10 is machine washable and maintains its structural integrity so that the sanitary utensil 10 may be cleaned using a high-heat dishwashing machine. In an alternate embodiment, the sanitary utensil 10 is disposable and meant for a single use.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A sanitary utensil, comprising:
a body including a first end and a second end, each of the first end and the second end disposed on a first horizontal plane, the first end of the body comprising a first contact point and the second end of the body comprising a second contact point, wherein the first contact point and the second contact point are configured to contact a surface when the body is placed thereon;
a middle portion of the body disposed between the first end and the second end of the body, the middle portion comprising an arcuate member including an apex disposed in a second horizontal plane, wherein the second horizontal plane is elevated above the first horizontal plane;
a tool disposed on the second end of the body extending upwardly in a direction opposing the first end of the body;
wherein the tool is configured to be elevated above a surface when the body is supported thereon via the first contact point and the second contact point.

2) The sanitary utensil of claim 1, wherein the first end of the body comprises a front portion and a rear portion disposed on opposing sides of the first contact point, each of the front portion and the rear portion extending upwardly from the first contact point, wherein the front portion tapers inwardly from the first contact point toward the tool portion, and wherein the rear portion tapers inwardly from the first contact point toward the second end of the body.

3) The sanitary utensil of claim 1, wherein the middle portion of the body tapers inwardly from the second end of the body towards the first end of the body.

4) The sanitary utensil of claim 1, further comprising an aperture disposed on the second end of the body.

5) The sanitary utensil of claim 1, wherein the second end of the body curves upwardly in a direction opposing the first end of the body.

6) The sanitary utensil of claim 1, wherein the tool comprises a fork.

7) The sanitary utensil of claim 1, wherein the tool comprises a spoon.

8) The sanitary utensil of claim 1, wherein the tool comprises a spatula.

9) The sanitary utensil of claim 1, wherein the body and the tool are composed of plastic.

10) The sanitary utensil of claim 1, wherein the body and the tool are composed of metal.

11) The sanitary utensil of claim 1, wherein the body and the tool are composed of wood.
